(19) United States
(12) Patent Application Publication
(10) Pub. No.: US 2026/0187815 A1
(43) Pub. Date: Jul. 2, 2026

(54) IMAGE PROCESSING SYSTEM, IMAGE PROCESSING METHOD, AND PROGRAM

(71) Applicants: Sony Interactive Entertainment Inc., Tokyo (JP); Sony Group Corporation, Tokyo (JP)

(72) Inventors: Ryota Ito, Kanagawa (JP); Hirotaka Asayama, Kanagawa (JP); Kaoru Saso, Tokyo (JP)

(73) Assignees: Sony Interactive Entertainment Inc., Tokyo (JP); Sony Group Corporation, Tokyo (JP)

(21) Appl. No.: 19/437,866

(22) Filed: Dec. 31, 2025

Related U.S. Application Data
(63) Continuation of application No. PCT/JP2024/022929, filed on Jun. 25, 2024.

(30) Foreign Application Priority Data
Jul. 3, 2023 (JP) 2023-109465

(51) Int. Cl. G06T 7/20; G06N 20/00; G06T 15/20

(52) U.S. Cl. CPC G06T 7/20; G06N 20/00; G06T 15/20

(57) ABSTRACT

At least one processor acquires n−1th movement information, which is information indicating a magnitude and a direction of movement of each pixel between an n−1th frame to be processed (22_n−1) and an nth frame to be processed (22_n), and acquires n−1th auxiliary information by setting the pixel values of one or more pixels of the n−1th cumulative feature information (46_n−1) to pixels at positions moved according to a pseudorandom number, based on the n−1th movement information.

### TECHNICAL FIELD

The present invention relates to an image processing system, an image processing method, and a program.

### BACKGROUND ART

Conventionally, art for using a machine learning model to estimate a high quality still image based on a low quality still image (super-resolution) is known (see Non-Patent Document 1 below).

### Prior Art Documents

### Non-Patent Documents

[Non-Patent Document 1] Chao Dong, Chen Change Loy, Kaiming He, Xiaoou Tang. Learning a Deep Convolutional Network for Image Super-Resolution, in Proceedings of European Conference on Computer Vision (ECCV), 2014

The inventors of the present application are considering a system having the following recursive configuration (hereinafter, sometimes referred to as “reference art”) in order to achieve super-resolution of moving images such as game screens. In other words, this system inputs the current frame, that is, a number n (nth) frame, and information on past frames, that is, information indicating the features of number 1 to n−1th frames (first to n−1th), into a machine learning model to improve the image quality of the nth frame (see FIG. 2). Generally speaking, by using information from past frames in addition to the current frame in this way, we can expect to improve the estimation performance of machine learning models.

However, according to the research of the inventors of the present application, when a moving image showing a scene with no or very little movement for a long time in at least a portion (hereinafter referred to as a “still screen”) is input, it has been found that using information from past frames actually leads to a decrease in estimation performance. Specifically, when a still screen is input to the system, artifacts may occur in the resulting moving image.

One reason for this is thought to be that machine learning models have not been trained enough to handle situations where parts of a moving image having no or very little movement remain in the same position for a long period of time. That is, from the viewpoint of the time and cost required for learning, there is a limit to the length of moving image that may be used for training a machine learning model. Furthermore, moving images in essence represent scenes with movement in the first place, so still screens such as those described above tend to be in short supply in the training data used to train machine learning models. For these reasons, it is difficult to train a machine learning model sufficiently on still screens.

Furthermore, it is generally known that when the same information is repeatedly input excessively to a machine learning model having a recursive configuration, artifacts in the output will be amplified. The above reference art also employs a recursive configuration, and when a still screen is input, the same information continues to be input excessively, resulting in amplified artifacts being observed in the output.

An object of the present invention is to provide an image processing system, an image processing method, and a program that make it possible to estimate a high quality still screen with fewer artifacts based on a low quality still screen.

### SUMMARY OF INVENTION

### Means for Solving Problem

An image processing system according to the present invention includes at least one processor, wherein the at least one processor acquires each of first to Nth input frames (N is a natural number of 2 or more) having a predetermined number of input pixels and corresponding to first to Nth frames to be processed, and inputs each of the input frames into a machine learning model and acquires first to Nth estimated frames, each having a number of estimated pixels equal to or greater than the number of input pixels; wherein the machine learning model includes a cumulative feature information output layer that is input with the nth input frame (n=2, 3, . . . , N) and n−1th auxiliary information based on n−1th cumulative feature information that is image information indicating features of the first to n−1th input frames and having the same number of pixels as the number of input pixels and that outputs the nth cumulative feature information that indicates features of the first to nth input frames, and an estimated frame output layer that is input with the nth cumulative feature information and that outputs the nth estimated frame; wherein the machine learning model is trained using a plurality of training data sets, each of which includes a training input frame having the number of input pixels and a training estimated frame having the number of estimated pixels; and wherein the at least one processor further acquires n−1th movement information that is information indicating a magnitude and a direction of movement of each pixel between the n−1th frame to be processed and the nth frame to be processed, and acquires the n−1th auxiliary information by setting the pixel values of one or more pixels of the n−1th cumulative feature information to pixels at positions moved according to a pseudorandom number, based on the n−1th movement information.

### BRIEF DESCRIPTION OF DRAWINGS

FIG. 1 A diagram illustrating one example of a hardware configuration of an image processing system.

FIG. 2 A diagram illustrating an overview of the reference art.

FIG. 3 A diagram schematically illustrating processing in the reference art.

FIG. 4 A diagram illustrating an overview of the image processing system.

FIG. 5 A diagram schematically illustrating the processing in the image processing system.

FIG. 6 A diagram describing a process of imparting pseudo-movement to cumulative feature information.

FIG. 7 A functional block diagram illustrating one example of functions implemented by the image processing system.

FIG. 8 A diagram describing processing of a rendering unit.

FIG. 9 A diagram describing processing in an input frame acquisition unit.

FIG. 10 A flowchart illustrating one example of the flow of the processing executed in the image processing system.

### EMBODIMENTS OF INVENTION

One example of an embodiment of an image processing system according to the present invention will be described below with reference to drawings.

### 1. Hardware Configuration of Image Processing System

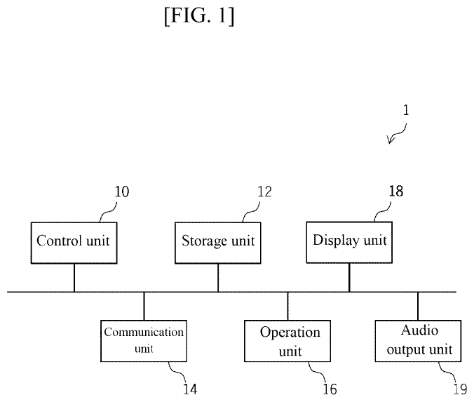

FIG. 1 illustrates one example of a hardware configuration of an image processing system 1. The image processing system 1 is, for example, a computer such as a game console (game device). As illustrated in FIG. 1, the image processing system 1 includes a control unit 10, a storage unit 12, a communication unit 14, an operation unit 16, a display unit 18, and an audio output unit 19.

The control unit 10, for example, includes a program control device such as a CPU that operates according to a program installed in the image processing system 1. The control unit 10 also includes a GPU (Graphics Processing Unit) that depicts images in a frame buffer based on graphics commands or data supplied from the CPU.

The storage unit 12 includes, for example, a main storage device such as ROM or RAM, and an auxiliary storage device such as an HDD or an SSD. The storage unit 12 stores a program or the like executed by the control unit 10. The storage unit 12 stores, for example, a game program (game software) in addition to a program for implementing various functions of the image processing system 1, which will be described later. The storage unit 12 also has a frame buffer area reserved for images depicted by the GPU.

The communication unit 14 is a communication interface such as an Ethernet (registered trademark) module or a wireless LAN module.

The operation unit 16 is a user interface such as a keyboard, mouse, or game console controller, and receives operation inputs from a user and outputs signals indicating the details of the inputs to the control unit 10.

The display unit 18 is a display device such as a liquid crystal display or an organic EL display, and displays various images according to instructions from the control unit 10.

The audio output unit 19 is, for example, a speaker or the like, and outputs audio represented by audio data generated by the image processing system 1.

In addition to the devices described above, the image processing system 1 may also include an optical disc drive that reads optical discs such as DVD-ROMs and Blu-ray (registered trademark) discs, a USB (Universal Serial Bus) port, or the like.

### 2. Overview of Reference Art

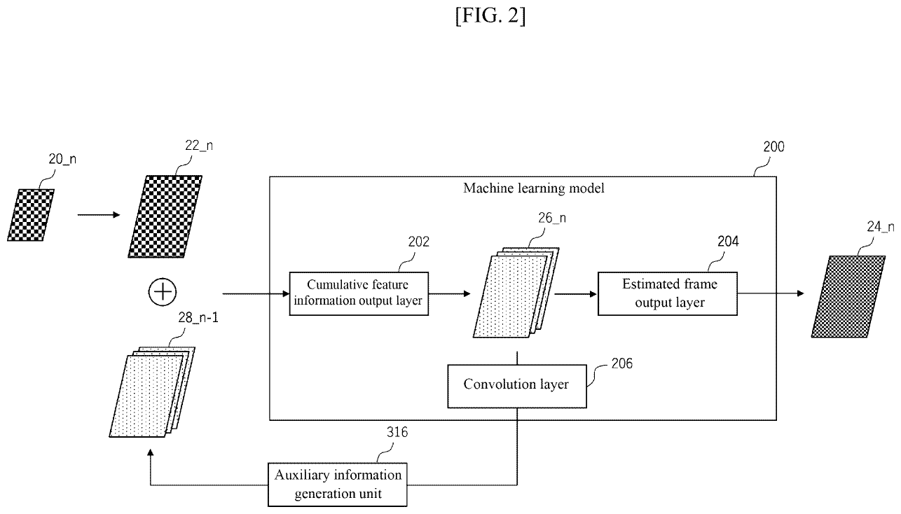

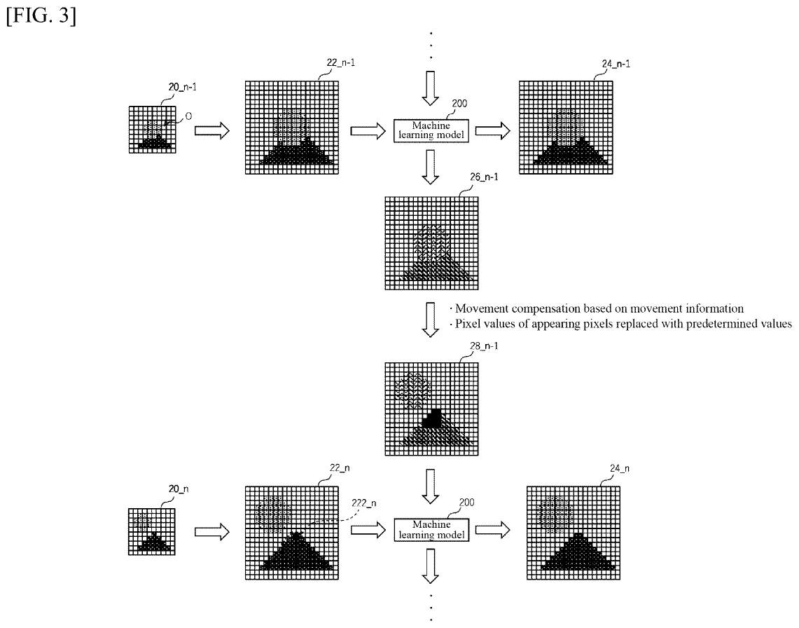

First, before describing the image processing system 1 according to the present embodiment, reference art that is the basis for the image processing system 1 according to the present embodiment will be described with reference to FIG. 2 and FIG. 3. FIG. 2 is a diagram illustrating an overview of the reference art. FIG. 3 is a diagram schematically illustrating processing in the reference art. Here, an example will be given in which the reference art is used to improve the image quality of gameplay moving images in a game. The gameplay moving image is a moving image generated in response to a game program executed by the control unit, user input received by the operation unit, or the like, and is constituted by a plurality of still images (frames) that is chronological data. The processing performed in the reference art is mainly as follows.

### (1) Generation of Frame to be Processed

First, the system according to the reference art generates an image (a frame to be processed) in which one or more game objects are depicted by executing rendering of three-dimensional data indicating the game objects as seen from a predetermined viewpoint. This frame to be processed is an image having a predetermined number of pixels (number of initial pixels) and a predetermined image quality (initial image quality) (see FIG. 3). The frames to be processed are generated at predetermined time intervals. The number of pixels in the frame to be processed is, for example, 1920×1080 (1080p). Each generated frame to be processed is not displayed directly on the display unit 18, but is temporarily saved in the storage unit 12 and is used for subsequent processing. In the following description, processing for an nth frame to be processed 20_n will be mainly given as an example, but similar processing is also executed for other frames to be processed (that is, n=2, 3, . . . , N).

### (2) Acquiring an Input Frame

The system according to the reference art acquires a frame (input frame) 22_n having a number of pixels (number of input pixels) greater than the number of initial pixels, based on the acquired frame to be processed 20_n. The number of input pixels is, for example, 3840×2160 (4 K). Specifically, the input frame 22_n is generated by executing enlargement and interpolation processing on the frame to be processed 20_n (see FIG. 3).

It should be noted that although the input frame 22_n has a larger number of pixels than the frame to be processed 20_n, image quality thereof is not necessarily improved sufficiently. In other words, the image quality of a frame does not simply refer to the number of pixels (high resolution). The image quality of a frame may be evaluated based on, for example, a high SN ratio, high spatial frequency reproducibility, high temporal stability (fewer artifacts or flicker when a plurality of frames is displayed consecutively), and the like, or a combination of these, when compared to a reference frame.

### (3) Acquiring an Estimated Frame

The system according to the reference art inputs the input frame 22_n to a machine learning model 200 to acquire an estimated frame 24_n. The estimated frame 24_n is an image having the same number of pixels (number of estimated pixels) as the number of input pixels and an image quality (estimated image quality) that is equal to or higher than the initial image quality (see FIG. 3).

Here, in addition to the input frame 22_n, n−1th auxiliary information 28_n−1 is input to the machine learning model 200 (see FIG. 2 and FIG. 3). The auxiliary information 28_n−1 is information based on n−1th cumulative feature information 26_n−1 that indicates features of first to n−1th input frames 22. Cumulative feature information 26 and auxiliary information 28 will be described in detail later.

The machine learning model 200 is a model trained using a plurality of training data sets, each of which includes a training input frame having a number of input pixels and a training estimated frame having a number of estimated pixels and estimated image quality.

### (4) Acquisition of Cumulative Feature Information

The machine learning model 200 has a cumulative feature information output layer 202 that receives the input frame 22_n and auxiliary information 28_n−1 and outputs nth cumulative feature information 26_n that indicates features of the first to nth input frames 22 (see FIG. 2). The system according to the reference art acquires the nth cumulative feature information 26_n.

The acquired nth cumulative feature information 26_n is input to an estimated frame output layer 204, and the nth estimated frame 24_n is output from the estimated frame output layer 204 (see FIG. 2). The acquired nth cumulative feature information 26_n is also saved in the storage unit 12 and is used to estimate an estimated frame 24_n+1 corresponding to a next frame to be processed (the n+1th frame to be processed) 20_n+1.

### (5) Acquisition of Auxiliary Information

As described above, the n−1th cumulative feature information 26_n−1 is information that indicates the features of the first to n−1th input frames 22 (and consequently the first to n−1th frames to be processed 20). In this way, by using the cumulative feature information 26_n−1, which is the cumulative information of past frames to be processed 20, to estimate the nth estimated frame 24_n, the amount of information available for estimation increases, making it possible to acquire a high quality estimated frame 24 n.

However, when there is movement or the like in the displayed game object between the n−1th frame to be processed 20_n−1 and the nth frame to be processed 20_n, when the nth input frame 22_n and the cumulative feature information 26_n−1 are input directly to the machine learning model 200, a phenomenon (so-called ghost phenomenon) may occur in which an afterimage of the game object that was displayed in the n−1th frame to be processed 20_n−1 is displayed.

Therefore, the system of the reference art acquires the n−1th auxiliary information 28_n−1 by applying various corrections described below to the cumulative feature information 26_n−1 based on information acquired during rendering (movement vectors, depth buffer, or the like) (see FIG. 2 and FIG. 3). As described above, the acquired n−1th auxiliary information 28_n−1 is input to the machine learning model 200 together with the nth input frame 22_n and is used to estimate the nth estimated frame 24_n.

As described above, according to the reference art of the present embodiment, an estimated frame 24 is estimated using auxiliary information 28, which is past cumulative information, in addition to the input frame 22 that corresponds to the current frame to be processed 20. This increases the amount of information available for estimation, making it possible to acquire a high quality estimated frame 24_n.

### 3. Overview of Image Processing System

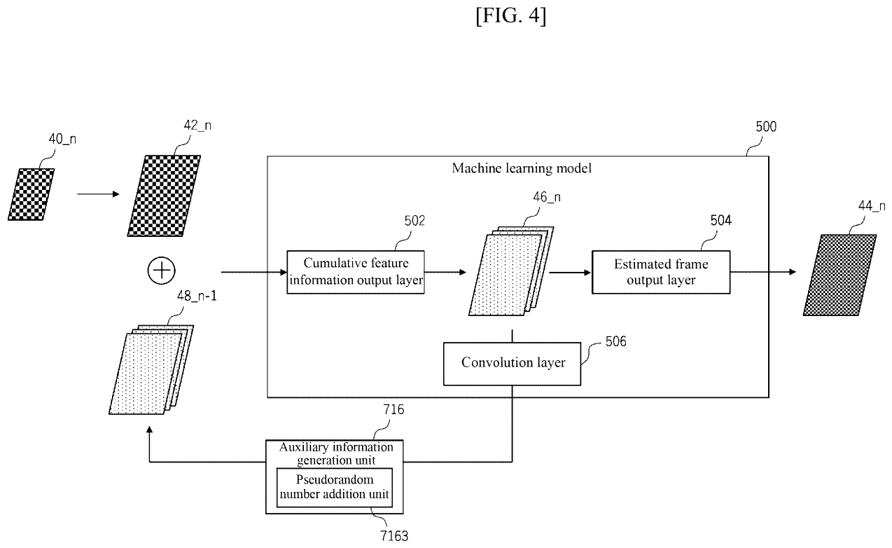

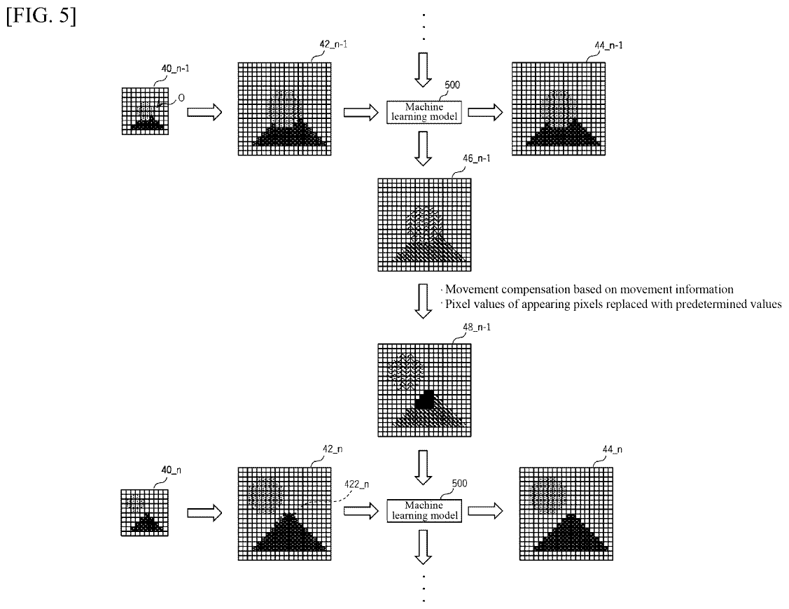

Next, an overview of the image processing system 1 will be described with reference to FIG. 4 and FIG. 5. FIG. 4 is a diagram illustrating an overview of the image processing system 1. FIG. 5 is a diagram schematically illustrating processing in the image processing system 1. In particular, the image processing system 1 is configured such that an auxiliary information generation unit 716 includes a pseudorandom number addition unit 7163 to enable estimation of a high quality still screen having fewer artifacts based on a low quality still screen. Note that description of configurations similar to the reference art will be omitted below.

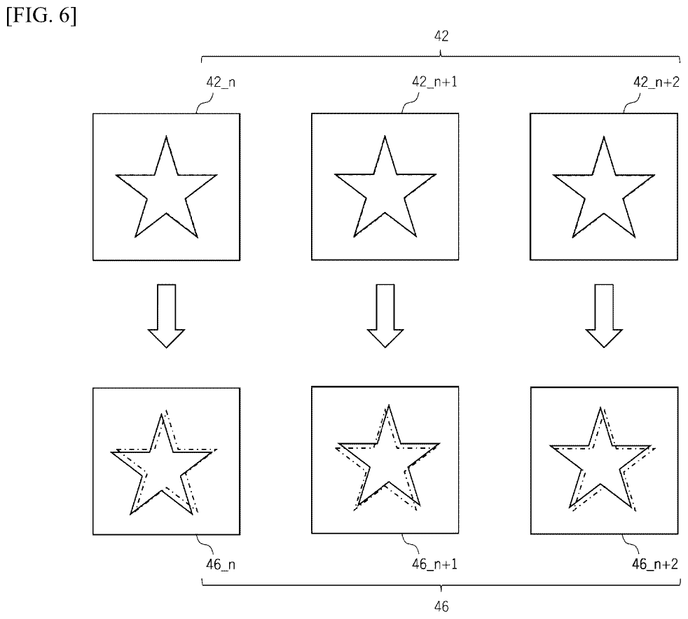

FIG. 6 is a diagram describing a process for imparting pseudo-movement to cumulative feature information. For example, as illustrated in FIG. 6, when there is no movement of the displayed object in input frames 42_n, 42_n+1, and 42_n+2, that is, when input frames 42_n, 42_n+1, and 42_n+2 are frames of a still screen, artifacts may occur in the resulting estimated frame 24.

One reason for this is thought to be that machine learning models have not been trained enough to handle situations where parts of a moving image having no or very little movement remain in the same position for a long period of time. That is, from the viewpoint of the time and cost required for learning, there is a limit to the length of moving image that may be used for training a machine learning model. Furthermore, moving images in essence represent scenes with movement in the first place, so still screens such as those described above tend to be in short supply in the training data used to train machine learning models. For these reasons, it is difficult to train a machine learning model sufficiently on still screens.

Furthermore, it is generally known that when the same information is repeatedly input excessively to a machine learning model having a recursive configuration, artifacts in the output will be amplified. A machine learning model 500 of the present embodiment also employs a recursive configuration, and when a still screen is input, the same information continues to be input excessively, resulting in amplified artifacts being observed in an output estimated frame 44.

That is, in the image processing system 1 of the present embodiment, based on n−1th movement information, setting the pixel values of one or more pixels of the n−1th cumulative feature information 46_n−1 having the magnitude of movement equal to or less than a predetermined threshold to pixels at positions moved according to a pseudorandom number. As a result, as illustrated in FIG. 6, the features indicated by cumulative feature information 46_n, 46_n+1, and 46_n+2 are slightly different from each other. As above, according to the image processing system 1 of the present embodiment, even when a still screen is to be estimated, each piece of cumulative feature information 46 indicates different features, and therefore this may suppress the occurrence of artifacts in the resulting estimated frame 44. The image processing system 1 will be described in detail below.

### 4. Functions Implemented by Image Processing System

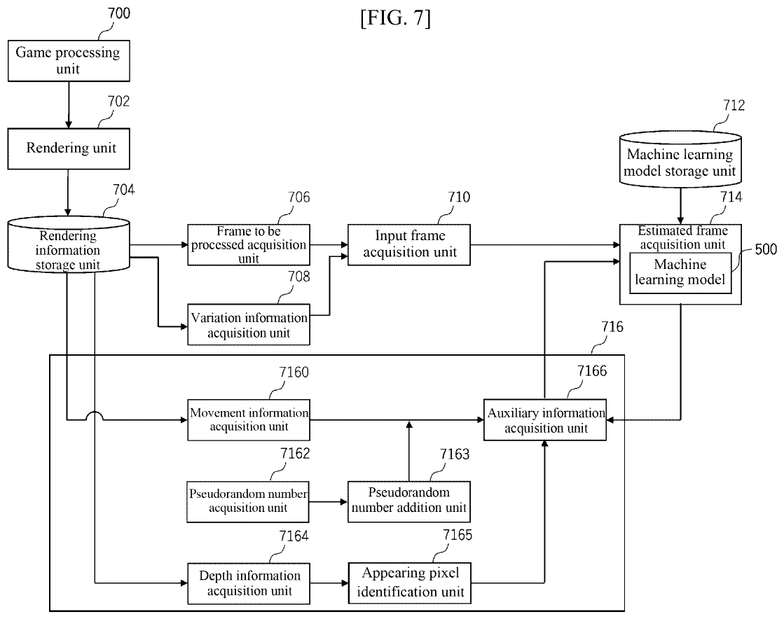

FIG. 7 is a functional block diagram illustrating one example of functions implemented by the image processing system 1. As illustrated in FIG. 7, in the image processing system 1, a game processing unit 700, a rendering unit 702, a rendering information storage unit 704, a frame to be processed acquisition unit 706, a variation information acquisition unit 708, an input frame acquisition unit 710, a machine learning model storage unit 712, an estimated frame acquisition unit 714, and an auxiliary information generation unit 716 are implemented. The auxiliary information generation unit 716 includes a movement information acquisition unit 7160, a pseudorandom number acquisition unit 7162, the pseudorandom number addition unit 7163, a depth information acquisition unit 7164, an appearing pixel identification unit 7165, and an auxiliary information acquisition unit 7166. The game processing unit 700, rendering unit 702, frame to be processed acquisition unit 706, variation information acquisition unit 708, input frame acquisition unit 710, estimated frame acquisition unit 714, movement information acquisition unit 7160, pseudorandom number acquisition unit 7162, pseudorandom number addition unit 7163, depth information acquisition unit 7164, appearing pixel identification unit 7165, and auxiliary information acquisition unit 7166 are mainly implemented by the control unit 10. The rendering information storage unit 704 and the machine learning model storage unit 712 are mainly implemented by the storage unit 12. The game processing unit 700, rendering unit 702, and rendering information storage unit 704 are functions provided by game software.

### Game Processing Unit

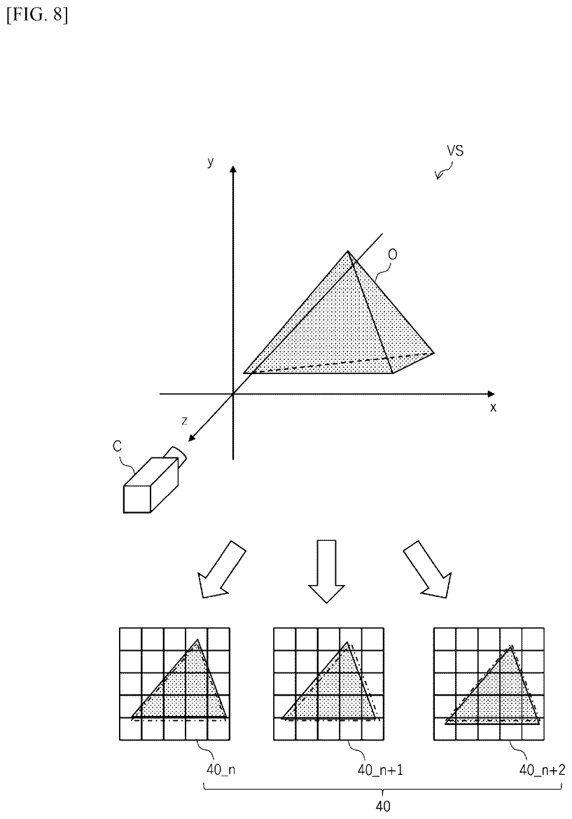

The game processing unit 700 executes various processes related to a game. The game processing unit 700 performs processes such as placing a game object O in a virtual three-dimensional space VS, operating or moving the game object O, or changing a viewpoint C from which a virtual three-dimensional space VS is viewed, in accordance with, for example, a game program executed by the control unit 10 or user input received by the operation unit 16 (see FIG. 8). The game object O is composed of primitives such as polygons represented by three-dimensional data. The three-dimensional data includes geometric information indicating positions or the like of vertices, topological information indicating how the vertices are connected, and attribute information such as color.

### Rendering Unit

FIG. 8 is a diagram describing processing of the rendering unit 702. The rendering unit 702 generates first to Nth (N is a natural number greater than or equal to 2) frames to be processed 40 by executing rendering (depiction processing) of three-dimensional data indicating one or more game objects O viewed from a predetermined viewpoint C. The rendering unit 702 executes rendering based on results of various processes executed by the game processing unit 700. Specifically, the rendering unit 702 executes vertex processing (vertex shading) and pixel processing (pixel shading) based on three-dimensional data indicating the game object O disposed in the virtual three-dimensional space VS. Vertex processing includes a coordinate transformation process (perspective projection) from a view coordinate system to a screen coordinate system, and a numerical value related to a variation in the viewpoint C is added to the perspective projection matrix (camera matrix) used in the coordinate transformation process, as described later. The rendering unit 702 may execute rendering based on light source information, depth information (depth buffer), texture information, normal information, or the like. In addition to the above processes, the rendering unit 702 may also execute processes to apply effects such as depth of field (DoF) or movement blur. The processing of the rendering unit 702 may be set as appropriate by game software developer or the like. Here, the game software developer or the like may adjust a texture MIP according to the number of estimated pixels of the estimated frame 44 or the like. This makes it possible to suppress noise such as moire patterns in the estimated frame 44.

Here, the rendering unit 702 generates each frame to be processed 40 by executing rendering so that the viewpoint C varies for each frame to be processed 40. Here, even when the game processing unit 700 fixes the viewpoint C at a predetermined position, the rendering unit 702 varies the viewpoint C for each frame to be processed 40. As a result, as illustrated in FIG. 8, the position of the displayed game object O varies in each of frames to be processed 40_n, 40_n+1, and 40n+2 . In other words, the rendering unit 702 applies jitter (jitter) when generating each frame to be processed 40. Specifically, the rendering unit 702 varies the viewpoint C for each frame to be processed 40 by adding a numerical value corresponding to a size less than one pixel, which differs for each frame to be processed 40, to the perspective projection matrix. The rendering unit 702 varies the viewpoint C for each frame to be processed 40 according to a predetermined rule. For example, a Halton sequence may be used as such a rule.

### Rendering Information Storage Unit

The rendering information storage unit 704 stores information necessary for the rendering process in the rendering unit 702 and information obtained as a result of the rendering process. For example, the rendering information storage unit 704 stores the frame to be processed 40. The rendering information storage unit 704 also stores variation information, movement information, and depth information. The variation information, movement information, and depth information will be described in detail later. Additionally, the rendering information storage unit 704 may store parameters used in coordinate transformation, light source information, texture information, normal information, or the like.

### Frame to Be Processed Acquisition Unit

The frame to be processed acquisition unit 706 acquires each of the first to Nth frames to be processed 40. Specifically, the frame to be processed acquisition unit 706 acquires each of the first to Nth frames to be processed 40 stored in the rendering information storage unit 704.

### Variation Information Acquisition Unit

The variation information acquisition unit 708 acquires variation information. The variation information acquisition unit 708 acquires the variation information stored in the rendering information storage unit 704. Specifically, the variation information is information indicating an amount of variation in the viewpoint C between before the variation and after the variation. The information indicating the amount of variation may also be called a variation vector indicating a direction and distance of the variation. For example, the Halton sequence described above contains information indicating the amount of variation in the viewpoint C, so this information may be used as variation information.

### Input Frame Acquisition Unit

The input frame acquisition unit 710 acquires each of the first to Nth input frames 42 based on each frame to be processed 40 by generating an input frame 42 that corresponds to the frame to be processed 40 and has a number of input pixels equal to or greater than the number of initial pixels. In the present embodiment, each input frame 42 has a number of input pixels that is greater than the number of initial pixels. That is, in the present embodiment, each input frame 42 is an enlarged image of the frame to be processed 40 corresponding to the input frame 42.

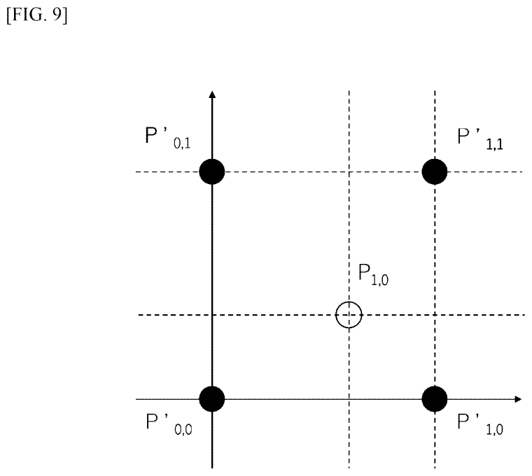

Specifically, the input frame acquisition unit 710 determines by interpolation pixel values at positions in the frame to be processed 40 corresponding to each pixel before the variation based on the variation information and each pixel of each frame to be processed 40, and generates each input frame 42. FIG. 9 is a diagram describing processing in the input frame acquisition unit 710. FIG. 9 illustrates an example in which the nth input frame 42_n is acquired. For example, as illustrated in FIG. 9, when defining a pixel center of a pixel in the input frame 42_n to be acquired as P_{1,0}, the input frame acquisition unit 710 determines a pixel value of P_{1,0} by bilinear (bilinear) interpolation based on the coordinates and pixel values of the pixel centers P′_{0,0}, P′_{1,0}, P′_{0,1}, and P′_{1,1} of the four pixels closest to P_{1,0} in the frame to be processed 40_n. Here, P′_{1,0} is located at a position shifted from P_{1,0} by the amount of variation indicated by the variation information. The pixel values of the pixels newly generated by the enlargement process are defined in the same manner. Various known techniques such as bicubic (bicubic) interpolation or Lanczos interpolation may be used as interpolation methods in addition to bilinear interpolation.

When rendering is executed so that the viewpoint C varies for each frame to be processed 40, the amount of time-series information increases, and by using each frame to be processed 40 obtained in this way (hereinafter referred to as a “frame to be subjected to variation processing”) for estimation, a higher quality estimated frame 44 may be obtained.

Conversely, when the frame to be subjected to variation processing (or an enlarged image thereof) is input directly into the machine learning model 500, the influence of the variation in viewpoint C described above may result in a decrease in the accuracy of estimation.

Therefore, as described above, in the image processing system 1, based on the variation information and each pixel of each frame to be processed 40, pixel values at positions in the frame to be processed 40 corresponding to each pixel before variation are defined by interpolation, and each input frame 42 is generated and input into the machine learning model 500. This corrects the influence of the variation in the viewpoint C, thereby preventing a decrease in the accuracy of estimation.

### Machine Learning Model

The machine learning model 500 is a model that estimates an nth estimated frame 44_n based on the nth input frame 42_n. Specifically, the machine learning model 500 is a model that estimates the nth estimated frame 44_n based on the nth input frame 42_n and n−1th auxiliary information 48_n−1. Specifically, the machine learning model 500 is a convolutional neural network (CNN: convolutional neural network). Known models such as a multi-layered ResNet having a residual connection mechanism, a so-called encoder-decoder type U-Net, or the like may be used as the machine learning model 500. The model described in Non-Patent Document 1 may be used as the machine learning model 500.

The machine learning model 500 is a model trained using a plurality of training data sets, each of which includes a training input frame having a number of input pixels, and a training estimated frame having an number of estimated pixels. Various known techniques such as backpropagation may be used to train the machine learning model 500.

Specifically, the machine learning model 500 includes a cumulative feature information output layer 502, an estimated frame output layer 504, and a convolution layer 506 (see FIG. 4).

The cumulative feature information output layer 502 is input with the nth input frame 42_n and the n−1th auxiliary information 48_n−1 based on the n−1th cumulative feature information 46_n−1 that indicates the features of the first to n−1th input frames 42 and outputs the nth cumulative feature information 46_n that indicates features of the first to nth input frames 42_n. The cumulative feature information output layer 502 may be composed of, for example, one or more convolution layers. The cumulative feature information 46_n−1 is image information (bitmap format information) having the same number of pixels as the number of input pixels. The cumulative feature information 46_n−1 may also be called a feature map that indicates the features of the first to n−1th input frames 42.

The cumulative feature information output layer 502 is input with a first input frame 42_1 and given auxiliary information and outputs first cumulative feature information 46_1. When n=1, there is no previous cumulative feature information 46 or auxiliary information 48, so pre-prepared given auxiliary information is input to the cumulative feature information output layer 502 together with the first input frame 42_1.

The estimated frame output layer 504 is input with the nth cumulative feature information 46_n and outputs the nth estimated frame 44_n. Similarly to the cumulative feature information output layer 502, the estimated frame output layer 504 may be composed of one or more convolution layers, for example. Alternatively, the estimated frame output layer 504 may be composed of one or more transposed convolution layers (deconvolution layers).

The convolution layer 506 is a layer that reduces the number of channels of the cumulative feature information 46 while maintaining the number of pixels. The cumulative feature information 46 output from the convolution layer 506 is subjected to processing in the auxiliary information acquisition unit 7166. The convolution layer 506 may reduce dimensions of the cumulative feature information 46, thereby reducing computational costs. The convolution layer 506 is, for example, a convolution layer having a kernel size of 1×1, but is not limited to this.

### Machine Learning Model Storage Unit

The machine learning model storage unit 712 stores the machine learning model 500. Specifically, the machine learning model storage unit 712 stores parameters of the machine learning model 500 (such as the number of convolutional layers, the number of nodes used in each convolutional layer, and the weight of each node).

### Estimated Frame Acquisition Unit

The estimated frame acquisition unit 714 inputs each input frame 42 to the machine learning model 500 and acquires first to Nth estimated frames 44, each having a number of estimated pixels greater than the number of initial pixels and equal to or greater than the number of input pixels. In the present embodiment, the estimated frame 44 has the same number of estimated pixels as the number of input pixels. More specifically, the estimated frame acquisition unit 714 inputs the nth input frame 42_n and the n−1th auxiliary information 48_n−1 to the machine learning model 500 to acquire the nth estimated frame 44_n.

### Auxiliary Information Generation Unit

The auxiliary information generation unit 716 generates the n−1th auxiliary information 48_n−1 based on the n−1th cumulative feature information 46_n−1. The auxiliary information generation unit 716 includes the movement information acquisition unit 7160, pseudorandom number sequence storage unit 7161, the pseudorandom number acquisition unit 7162, the pseudorandom number addition unit 7163, the depth information acquisition unit 7164, the appearing pixel identification unit 7165, and the auxiliary information acquisition unit 7166.

### Movement Information Acquisition Unit

The movement information acquisition unit 7160 acquires n−1th movement information, which is information that indicates a magnitude and a direction of movement from the n−1th frame to be processed 40_n−1 to the nth frame to be processed 40_n. Specifically, the n−1th movement information is image information (bitmap format information) that has the same number of pixels as the number of input pixels and indicates the magnitude and the direction of movement of each pixel between the n−1th frame to be processed 40_n−1 and the nth frame to be processed 40_n. In other words, the pixel value of each pixel in the n−1th movement information indicates the magnitude and the direction of movement of each pixel between the n−1th frame to be processed 40n−1 and the nth frame to be processed 40_n. That is, the pixel value of each pixel in the n−1th movement information is a two-dimensional vector indicating the magnitude and the direction of movement of each pixel between the n−1th frame to be processed 40_n−1 and the nth frame to be processed 40_n. The movement information is also called a motion vector (motion vector). Specifically, the movement information acquisition unit 7160 acquires original movement information having the same number of pixels as the number of initial pixels, and executes enlargement and interpolation processing on the original movement information to acquire movement information having the same number of pixels as the number of input pixels.

### Pseudorandom Number Acquisition Unit

The pseudorandom number acquisition unit 7162 acquires a pseudorandom number for each piece of cumulative feature information 46. Specifically, the pseudorandom number acquisition unit 7162 acquires a pseudorandom number for each piece of cumulative feature information 46 by generating a pseudorandom number according to a pseudorandom number generator. The pseudorandom number is either positive or negative. Various known pseudorandom number generators may be used as the pseudorandom number generator. The pseudorandom number acquisition unit 7162 may acquire a pseudorandom number for each piece of cumulative feature information 46 from a random number table stored in advance in the storage unit 12. However, if the cycle of pseudorandom numbers is short, such as several tens to several hundreds, there is a risk that the displayed estimated frame 24 will look visually unnatural. In this regard, it is preferable to generate pseudorandom numbers in accordance with the pseudorandom number generator, since the pseudorandom number generator is able to generate pseudorandom numbers of a sufficient length.

More specifically, the pseudorandom number acquisition unit 7162 acquires two pseudorandom numbers (a first pseudorandom number and a second pseudorandom number) for each piece of cumulative feature information 46. The pseudorandom number acquisition unit 7162 may also acquire a two-dimensional pseudorandom number vector for each piece of cumulative feature information 46. Here, it is preferable that the pseudorandom number acquisition unit 7162 acquires two pseudorandom numbers for each piece of cumulative feature information 46 such that the values of the two pseudorandom numbers for each piece of cumulative feature information 46 are mutually different. For example, it is preferable that the pseudorandom number acquisition unit 7162 acquires the two pseudorandom numbers for each piece of cumulative feature information 46 by generating each of the two pseudorandom numbers based on each of two mutually different random number seeds.

More specifically, the pseudorandom number acquisition unit 7162 acquires a pseudorandom number for each piece of cumulative feature information 26 so that the average value of the pseudorandom numbers associated with each piece of the first to Nth cumulative feature information 26 is zero. Specifically, the pseudorandom number acquisition unit 7162 acquires a pseudorandom number for each piece of cumulative feature information 26 so that the average value of the first pseudorandom numbers associated with each piece of the first to Nth cumulative feature information 26 is 0, and the average value of the second pseudorandom numbers associated with each piece of the first to Nth cumulative feature information 26 is 0. As a result, in each cumulative feature information 26, the magnitude of movement in the pseudorandom number addition unit 7163 to be described later becomes so small that it could be evaluated as not having moved when averaged over time, thereby minimizing the impact on estimation and suppressing the occurrence of artifacts.

Furthermore, the pseudorandom number acquisition unit 7162 acquires a pseudorandom number for each piece of cumulative feature information 26 so that the pseudorandom number associated with each piece of the first to Nth cumulative feature information 26 follows a uniform distribution. Specifically, the pseudorandom number acquisition unit 7162 acquires a pseudorandom number for each piece of cumulative feature information 26 so that the first pseudorandom number associated with each piece of the first to Nth cumulative feature information 26 follows a uniform distribution, and the second pseudorandom number associated with each piece of the first to Nth cumulative feature information 26 follows a uniform distribution. This makes it possible to more suitably suppress the influence on estimation and to suppress the occurrence of artifacts. The pseudorandom numbers associated with each piece of the first to Nth cumulative feature information 26 may follow a normal distribution, for example.

Furthermore, the pseudorandom number acquisition unit 7162 acquires a pseudorandom number for each piece of cumulative feature information 26 so that each pseudorandom number associated with each piece of the first to Nth cumulative feature information 26 has a magnitude within a predetermined range. Specifically, it is preferable that the pseudorandom number has a magnitude of 0.1 or less. Specifically, the pseudorandom number acquisition unit 7162 acquires a pseudorandom number for each piece of the cumulative feature information 26 so that the first pseudorandom number associated with each piece of the first to Nth cumulative feature information 26 is a magnitude within a predetermined range and the second pseudorandom number associated with each piece of the first to Nth cumulative feature information 26 is a magnitude within a predetermined range. Thus, the occurrence of artifacts may be suppressed while further suppressing the impact on estimation.

### Pseudorandom Number Addition Unit

The pseudorandom number addition unit 7163 adds a pseudorandom number associated with the n−1th cumulative feature information to the pixel values of one or more pixels of the n−1th movement information. Here, since the pixel value of each pixel included in the n−1th movement information is a two-dimensional vector having two elements, the pseudorandom number addition unit 7163, more specifically, adds each of two pseudorandom numbers associated with the n−1th cumulative feature information to each of the two elements.

Specifically, the pseudorandom number addition unit 7163 adds a pseudorandom number associated with the n−1th cumulative feature information to the pixel values of pixels of the n−1th movement information having the magnitude of movement equal to or less than a predetermined threshold. The pseudorandom number addition unit 7163 adds a pseudorandom number associated with the n−1th cumulative feature information to the pixel values of all pixels of the n−1th movement information.

According to the pseudorandom number addition unit 7163 above, even when a still screen is to be estimated, each piece of cumulative feature information 46 indicates different features, and therefore this may suppress the occurrence of artifacts in the resulting estimated frame 44.

### Depth Information Acquisition Unit

The depth information acquisition unit 7164 acquires n−1th depth information indicating the depth of each pixel of the n−1th frame to be processed 40_n−1, and nth depth information indicating the depth of each pixel of the nth frame to be processed 40_n. Depth information is specifically image information having the same number of pixels as the number of input pixels (bitmap format information). The depth information is also called a depth buffer or a Z buffer. Specifically, the depth information acquisition unit 7164 acquires original depth information having the same number of pixels as the number of initial pixels, and then executes enlargement and interpolation processing on the original depth information to acquire depth information having the same number of pixels as the number of input pixels.

### Appearing Pixel Identification Unit

Based on the n−1th depth information and the nth depth information, the appearing pixel identification unit 7165 identifies an nth appearing pixel 422_n, which, among the pixels of the nth input frame 42_n, is a pixel in which all or part of the game object O that is not displayed in the n−1th input frame 42_n−1 is displayed (see FIG. 5). Specifically, the appearing pixel identification unit 7165 defines the nth appearing pixel 422_n based on the difference between the n−1th depth information and the nth depth information. The appearing pixel identification unit 7165 may identify the nth appearing pixel 422_n based on an n−1th perspective projection matrix associated with the n−1th input frame 42_n−1 and an nth perspective projection matrix associated with the nth input frame 42_n. Furthermore, the appearing pixel identification unit 7165 may define the nth appearing pixel 422_n by using the n−1th movement information. More specifically, the appearing pixel identification unit 7165 defines the nth appearing pixel 422_n and generates nth appearing pixel information, which is image information indicating the position of the nth appearing pixel 422_n.

### Auxiliary Information Acquisition Unit

The auxiliary information acquisition unit 7166 acquires the n−1th auxiliary information 48_n−1 by applying movement compensation to the n−1th cumulative feature information 46_n−1 based on the n−1th movement information. In the present embodiment, the auxiliary information acquisition unit 7166 acquires the n−1th auxiliary information 48_n−1 by applying movement compensation to the n−1th cumulative feature information 46_n−1 based on the n−1th movement information to which a pseudorandom number associated with the n−1th cumulative feature information 26_n−1 has been added. Movement compensation refers to the process of moving a pixel at a position x in the n−1th cumulative feature information 46_n to a position x', for example, when a pixel at the position x in the n−1th input frame 42_n−1 has moved to the position x′ in the nth input frame 42_n (see FIG. 5). That is, the auxiliary information acquisition unit 7166 acquires the n−1th auxiliary information 48_n−1 by setting the pixel values of one or more pixels of the n−1th cumulative feature information 46_n−1 to pixels at positions moved according to the magnitude and the direction of movement of the pixels, based on the n−1th movement information to which a pseudorandom number associated with the n−1th cumulative feature information 26_n−1 is added.

In the event that there is movement of the game object O between the nth frame to be processed 40_n and the n−1th frame to be processed 40_n−1, when acquiring the nth estimated frame 44_n and inputting the nth input frame 42_n and the n−1th cumulative feature information 46_n−1 directly into the machine learning model 500, a ghost phenomenon may occur in which an afterimage of the game object O that was displayed in the nth input frame 42_n is displayed in the output nth estimated frame 44_n.

Therefore, in the image processing system 1, as described above, movement compensation is applied to the n−1th cumulative feature information 46_n−1 based on the n−1th movement information to acquire the n−1th auxiliary information 48_n−1, and when acquiring the nth estimated frame 44_n, this n−1th auxiliary information 48_n−1 is input to the machine learning model 500. This makes it possible to suppress the above ghost phenomenon.

Furthermore, in the present embodiment, the n−1th auxiliary information 48_n−1 is acquired by applying movement compensation to the n−1th cumulative feature information 46_n−1 based on the n−1th movement information to which a pseudorandom number associated with the n−1th cumulative feature information 26_n−1 has been added. Thus, even when a still screen is to be estimated, each piece of cumulative feature information 46 indicates different features, and therefore this may suppress the occurrence of artifacts in the resulting estimated frame 44.

Furthermore, the auxiliary information acquisition unit 7166 acquires the n−1th auxiliary information 48_n−1 by replacing the pixel value of the nth appearing pixel 422_n in the n−1th cumulative feature information 46_n−1 with a predetermined value. Specifically, the auxiliary information acquisition unit 7166 acquires the n−1th auxiliary information 48_n−1 based on the nth appearing pixel information by replacing the pixel value of the nth appearing pixel 422_n in the n−1th cumulative feature information 46_n−1 with a predetermined value. The predetermined value may be a constant value such as 0 (black), or may be the pixel value of the nth appearing pixel 422_n in the nth input frame 42_n.

When all or part of a game object O that is not displayed in the n−1th frame to be processed 40_n−1 is displayed in the nth frame to be processed 40_n, and the nth input frame 42_n and the n−1th cumulative feature information 46_n−1 are input directly into the machine learning model 500 when acquiring the nth estimated frame 44_n, the above ghost phenomenon may occur in the output nth estimated frame 44_n.

Therefore, as described above, the image processing system 1 identifies the nth appearing pixel 422_n, which, among the pixels of the nth input frame 42_n, is a pixel where all or part of the game object O that is not displayed in the n−1th input frame 42_n−1 is displayed, and acquires the n−1th auxiliary information 48_n−1 by replacing the pixel value of the nth appearing pixel 422_n in the n−1th cumulative feature information 46_n−1 with a predetermined value. This makes it possible to suppress the above ghost phenomenon.

### 4. Processing Executed in Image Processing System

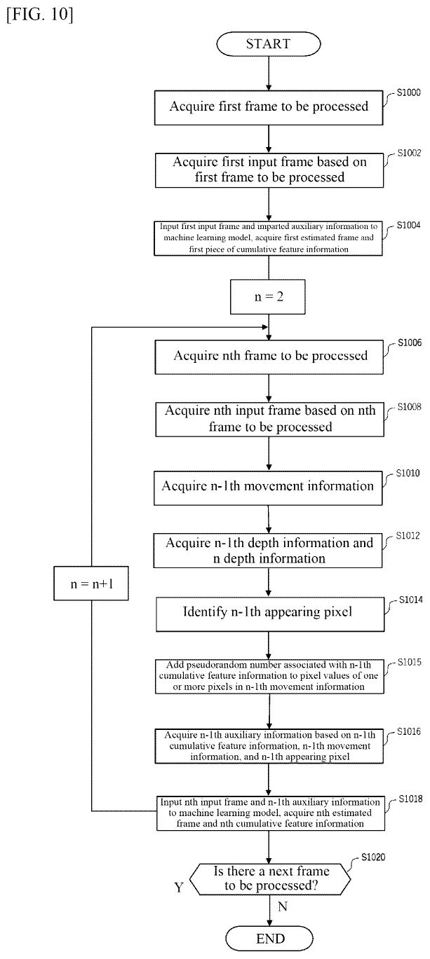

FIG. 10 is a flowchart illustrating one example of the flow of the processing executed in the image processing system 1. The process illustrated in FIG. 10 is executed by the control unit 10 operating in accordance with a program stored in the storage unit 12.

(1) Processing When n=1

First, the control unit 10 acquires a first frame to be processed 40_1 (S1000). The control unit 10 acquires a first input frame 42_1 based on the first frame to be processed 40_1 (S1002). Then, the control unit 10 inputs the first input frame 42_1 and given auxiliary information to the machine learning model 500, and acquires a first estimated frame 44 1 and first cumulative feature information 46_1 (S1004).

(2) Processing When n≥2

The control unit 10 acquires the nth frame to be processed 40_n (S1006). The control unit 10 acquires the nth input frame 42_n based on the nth frame to be processed 40_n (S1008).

Next, the control unit 10 acquires the n−1th movement information (S1010). In addition, the control unit 10 acquires the n−1th depth information and the nth depth information (S1012) and identifies the nth appearing pixel 422_n based on the n−1th depth information and the nth depth information (S1014). The control unit 10 adds a pseudorandom number associated with the n−1th cumulative feature information to the pixel value of one or more pixels of the n−1th movement information (S1015). The control unit 10 acquires the n−1th auxiliary information 48_n−1 based on the n−1th cumulative feature information 46_n−1, the n−1th movement information, and the nth appearing pixel 422_n (S1016). The control unit 10 then inputs the nth input frame 42_n and the n−1th auxiliary information 48_n−1 to the machine learning model 500 to acquire the nth estimated frame 44_n and the nth cumulative feature information 46_n (S1018). The control unit 10 determines whether the next frame exists (S1020), and if determining that the next frame exists (S1020: Y), increments n to n+1 and repeats the processes of S1006 to S1018. If the control unit 10 determines that the next frame does not exist (S1020: N), it ends this process. If the control unit 10 determines that the next frame does not exist (S1020: N), it may cause the display unit 18 to directly display the first to Nth estimated frames 44.

### 5. Summary

According to the image processing system 1 of the present embodiment described above, the nth estimated frame 44_n is estimated using the n−1th cumulative feature information 46_n−1 that indicates the features of the first to n−1th input frames 42. That is, in addition to the information on the nth frame to be processed 40_n, the information on the first to n−1th frames to be processed 40 may be used for estimation, so the amount of information available for estimation increases, and a high quality estimated frame 44_n may be acquired.

Furthermore, according to the image processing system 1 of the present embodiment, even when a still screen is to be estimated, each piece of cumulative feature information 46 indicates different features, and therefore this may suppress the occurrence of artifacts in the resulting estimated frame 44.

The present invention is not limited to the embodiment described above. Furthermore, the specific character strings or numerical values described above and the specific character strings or numerical values in the drawings are examples, and the present invention is not limited to these character strings or numerical values.

For example, in the present embodiment, an example has been given in which the number of input pixels is greater than the number of initial pixels and the number of input pixels is the same as the number of estimated pixels, but the number of input pixels may be the same as the number of initial pixels and the number of estimated pixels may be greater than the number of input pixels. That is, the input frame 42 need not necessarily be an enlarged version of the frame to be processed 40.

In addition, in the present embodiment, a case is described where processing by the auxiliary information acquisition unit 7166 is performed after processing by the pseudorandom number addition unit 7163, but after processing by the auxiliary information acquisition unit 7166, the pseudorandom number vector acquired by the pseudorandom number acquisition unit 7162 may be added to the pixel values of one or more pixels of the auxiliary information 28. That is, the auxiliary information acquisition unit 7166 may be configured to acquire the n−1th auxiliary information by setting the pixel values of one or more pixels of the n−1th cumulative feature information to pixels at positions moved according to the pseudorandom number, based on the n−1th movement information.

In addition, in the present embodiment, an example has been given of a case in which a pseudorandom number common to one or more pixels is added to the pixel values of the one or more pixels of the n−1th movement information, but it is also possible to add mutually different pseudorandom numbers to each of the pixel values of the one or more pixels of the n−1th movement information.

Furthermore, the frame to be processed 40 may be input directly to the machine learning model 500.

### 6. Postscript

(1) An image processing system including at least one processor,
wherein the at least one processor:
   acquires each of first to Nth input frames (N is a natural number of 2 or more) having a predetermined number of input pixels and corresponding to first to Nth frames to be processed, and
   inputs each of the input frames into a machine learning model and acquires first to Nth estimated frames, each having a number of estimated pixels equal to or greater than the number of input pixels;
wherein the machine learning model includes
   a cumulative feature information output layer that is input with the nth input frame (n=2, 3, . . . , N) and n−1th auxiliary information based on n−1th cumulative feature information that is image information that indicates features of the first to n−1th input frames and having the same number of pixels as the number of input pixels and that outputs the nth cumulative feature information that indicates features of the first to nth input frames, and
   an estimated frame output layer that is input with the nth cumulative feature information and that outputs the nth estimated frame; and
the machine learning model is trained using a plurality of training data sets, each of which includes a training input frame having the number of input pixels and a training estimated frame having the number of estimated pixels; and
the at least one processor further:
acquires n−1th movement information that is information indicating a magnitude and a direction of movement of each pixel between the n−1th frame to be processed and the nth frame to be processed, and
acquires the n−1th auxiliary information by setting the pixel values of one or more pixels of the n−1th cumulative feature information to pixels at positions moved according to a pseudorandom number, based on the n−1th movement information.
(2) The image processing system according to (1), wherein the at least one processor acquires the n−1th auxiliary information by setting the pixel values of one or more pixels of the n−1th cumulative feature information having the magnitude of movement equal to or less than a predetermined threshold to pixels at positions moved according to the pseudorandom number, based on the n−1th movement information.
(3) The image processing system according to (1) or (2), wherein the at least one processor acquires the pseudorandom number for each piece of cumulative feature information so that an average of the pseudorandom numbers associated with the first to Nth cumulative feature information is zero.
(4) The image processing system according to any of (1) to (3), wherein the pseudorandom number is acquired for each piece of cumulative feature information so that the pseudorandom numbers associated with the first to Nth cumulative feature information follows uniform distribution.
(5) The image processing system according to any of (1) to (4), wherein the pseudorandom number is acquired for each piece of cumulative feature information so that each of the pseudorandom numbers associated the first to Nth cumulative feature information has a magnitude within a predetermined range.
(6) The image processing system according to any of (1) to (5), wherein each of the frames to be processed is an image obtained by executing rendering of three-dimensional data indicating one or more objects as seen from a predetermined viewpoint.
(7) The image processing system according to any of (1) to (6), wherein the at least one processor acquires the n−1th auxiliary information based on the n−1th movement information by applying movement compensation to the n−1th cumulative feature information.
(8) The image processing system according to any of (1) to (7), wherein the cumulative feature information output layer is input with the first input frame and given auxiliary information and outputs the first cumulative feature information.

1. An image processing system comprising:
one or more storage media storing instructions; and
one or more processors configured to execute the instructions to cause the image processing system to:
acquire each of first to Nth input frames (N is a natural number of 2 or more) having a predetermined number of input pixels and corresponding to first to Nth frames to be processed; and
input each of the input frames into a machine learning model and acquire first to Nth estimated frames, each having a number of estimated pixels equal to or greater than the number of input pixels, wherein the machine learning model is trained using a plurality of training data sets, each of which includes a training input frame having the number of input pixels and a training estimated frame having the number of estimated pixels and includes:
a cumulative feature information output layer that is input with the nth input frame (n=2, 3, . .. , N) and n−1th auxiliary information based at least in part on n−1th cumulative feature information that is image information that indicates features of the first to n−1th input frames and having the same number of pixels as the number of input pixels and that outputs the nth cumulative feature information that indicates features of the first to nth input frames; and
an estimated frame output layer that is input with the nth cumulative feature information and that outputs the nth estimated frame;
acquire n−1th movement information indicating a magnitude and a direction of movement of each pixel between the n−1th frame to be processed and the nth frame to be processed; and
acquire the n−1th auxiliary information by setting the pixel values of one or more pixels of the n−1th cumulative feature information to pixels at positions moved according to a pseudorandom number, based at least in part on the n−1th movement information.

2. The image processing system of claim 1, wherein the one or more processors are further configured to execute the instructions to cause the image processing system to:
acquire the n−1th auxiliary information by setting the pixel values of one or more pixels of the n−1th cumulative feature information having a magnitude of movement equal to or less than a predetermined threshold to pixels at positions moved according to the pseudorandom number, based at least in part on the n−1th movement information.

3. The image processing system of claim 1, wherein one or more processors are further configured to execute the instructions to cause the image processing system to:
acquire the pseudorandom number for each piece of cumulative feature information so that an average of the pseudorandom numbers associated with the first to Nth cumulative feature information is zero.

4. The image processing system of claim 1, wherein the pseudorandom number is acquired for each piece of cumulative feature information so that the pseudorandom numbers associated with the first to Nth cumulative feature information follow a uniform distribution.

5. The image processing system of claim 1, wherein the pseudorandom number is acquired for each piece of cumulative feature information so that each of the pseudorandom numbers associated with the first to Nth cumulative feature information has a magnitude within a predetermined range.

6. The image processing system according of claim 1, wherein each of the frames to be processed is an image acquired by executing rendering of three-dimensional data indicating one or more objects as seen from a predetermined viewpoint.

7. The image processing system of claim 1, wherein the one or more processors are further configured to execute the instructions to cause the image processing system to:
acquire the n−1th auxiliary information by applying movement compensation to the n−1th cumulative feature information based at least in part on the n−1th movement information.

8. The image processing system of claim 1, wherein the cumulative feature information output layer is input with the first input frame and given auxiliary information and outputs the first cumulative feature information.

9. An image processing method comprising:
acquiring each of first to Nth input frames (N is a natural number of 2 or more) having a predetermined number of input pixels and corresponding to first to Nth frames to be processed; and
inputting each of the input frames into a machine learning model and acquiring first to Nth estimated frames, each having a number of estimated pixels equal to or greater than the number of input pixels, wherein the machine learning model is trained using a plurality of training data sets, each of which includes a training input frame having the number of input pixels and a training estimated frame having the number of estimated pixels and includes:
a cumulative feature information output layer that is input with the nth input frame (n=2, 3, . . . , N) and n−1th auxiliary information based at least in part on n−1th cumulative feature information that is image information that indicates features of the first to n−1th input frames and having the same number of pixels as the number of input pixels and that outputs the nth cumulative feature information that indicates features of the first to nth input frames; and
an estimated frame output layer that is input with the nth cumulative feature information and that outputs the nth estimated frame;
acquiring, n−1th movement information indicating a magnitude and a direction of movement of each pixel between the n−1th input frame the nth input frame; and
setting the pixel values of one or more pixels of the n−1th cumulative feature information to pixels at positions moved according to a pseudorandom number, based at least in part on the n−1th movement information.

10. (canceled)

11. The method of claim 9, further comprising:
acquiring the n−1th auxiliary information by setting the pixel values of one or more pixels of the n−1th cumulative feature information having a magnitude of movement equal to or less than a predetermined threshold to pixels at positions moved according to the pseudorandom number, based at least in part on the n−1th movement information.

12. The method of claim 9, wherein further comprising:
acquiring the pseudorandom number for each piece of cumulative feature information so that an average of the pseudorandom numbers associated with the first to Nth cumulative feature information is zero.

13. The method of claim 9, wherein the pseudorandom number is acquired for each piece of cumulative feature information so that the pseudorandom numbers associated with the first to Nth cumulative feature information follow a uniform distribution.

14. The method of claim 9, wherein the pseudorandom number is acquired for each piece of cumulative feature information so that each of the pseudorandom numbers associated with the first to Nth cumulative feature information has a magnitude within a predetermined range.

15. The method of claim 9, wherein each of the frames to be processed is an image acquired by executing rendering of three-dimensional data indicating one or more objects as seen from a predetermined viewpoint.

16. The method of claim 9, wherein the cumulative feature information output layer is input with the first input frame and given auxiliary information and outputs the first cumulative feature information.

17. One or more non-transitory computer-readable storage media storing instructions that, upon execution by one or more processors of a system, cause the system to:
acquire each of first to Nth input frames (N is a natural number of 2 or more) having a predetermined number of input pixels and corresponding to first to Nth frames to be processed; and
input each of the input frames into a machine learning model and acquire first to Nth estimated frames, each having a number of estimated pixels equal to or greater than the number of input pixels, wherein the machine learning model is trained using a plurality of training data sets, each of which includes a training input frame having the number of input pixels and a training estimated frame having the number of estimated pixels and includes:
a cumulative feature information output layer that is input with the nth input frame (n=2, 3, . . . , N) and n−1th auxiliary information based at least in part on n−1th cumulative feature information that is image information that indicates features of the first to n−1th input frames and having the same number of pixels as the number of input pixels and that outputs the nth cumulative feature information that indicates features of the first to nth input frames; and
an estimated frame output layer that is input with the nth cumulative feature information and that outputs the nth estimated frame;
acquire n−1th movement information indicating a magnitude and a direction of movement of each pixel between the n−1th input frame the nth input frame; and
set the pixel values of one or more pixels of the n−1th cumulative feature information to pixels at positions moved according to a pseudorandom number based at least in part on the n−1th movement information.

18. The one or more non-transitory computer-readable storage media of claim 17, wherein the pseudorandom number is acquired for each piece of cumulative feature information so that the pseudorandom numbers associated with the first to Nth cumulative feature information follow a uniform distribution.

19. The one or more non-transitory computer-readable storage media of claim 17, wherein the pseudorandom number is acquired for each piece of cumulative feature information so that each of the pseudorandom numbers associated with the first to Nth cumulative feature information has a magnitude within a predetermined range.

20. The one or more non-transitory computer-readable storage media of claim 17, wherein each of the frames to be processed is an image acquired by executing rendering of three-dimensional data indicating one or more objects as seen from a predetermined viewpoint.

21. The one or more non-transitory computer-readable storage media of claim 17, wherein the cumulative feature information output layer is input with the first input frame and given auxiliary information and outputs the first cumulative feature information.
